(19) United States
(12) Patent Application Publication
(10) Pub. No.: US 2023/0109733 A1
(43) Pub. Date: Apr. 13, 2023

(54) NEGATIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Jongheon SEOL, Yongin-si (KR); Minjae KIM, Yongin-si (KR); Soochan KIM, Yongin-si (KR); Hyeseung JUNG, Yongin-si (KR); Chaewoong CHO, Yongin-si (KR); Minyoung HONG, Yongin-si (KR); Junghyun NAM, Yongin-si (KR); Sungsoo HAN, Yongin-si (KR)

(21) Appl. No.: 17/937,260

(22) Filed: Sep. 30, 2022

(30) Foreign Application Priority Data
Oct. 7, 2021 (KR) 10-2021-0133339

(51) Int. Cl. H01M 4/38; H01M 10/0525; H01M 4/62; H01M 4/04

(52) U.S. Cl. CPC H01M 4/386; H01M 10/0525; H01M 4/625; H01M 4/0404; H01M 2004/021

(57) ABSTRACT

Disclosed is a negative electrode for a rechargeable lithium battery and a rechargeable lithium battery including the same, and the negative electrode includes a current collector and a negative active material layer on the current collector and including a negative active material and a conductive material, the negative active material including a silicon-based active material and the conductive material includes carbon nanotube, wherein the negative active material and the conductive material are included in the negative active material layer in order to satisfy a relationship of Equation 1 and Equation 2.

26<A*B−{(C*D)/10}<55 Equation 1

600≤D≤1000 Equation 2

### CROSS-REFERENCE TO RELATED APPLICATION

This application claims priority to and the benefit of Korean Patent Application No. 10-2021-0133339 filed in the Korean Intellectual Property Office on Oct. 7, 2021, the entire contents of which are hereby incorporated by reference.

### BACKGROUND

### 1. Field

Embodiments of the present disclosure relate to a negative electrode for a rechargeable lithium battery and a rechargeable lithium battery including the same.

### 2. Description of the Related Art

Recently, the rapid spread of electronic devices such as mobile phones, laptop computers, and electric vehicles using batteries require substantial or surprising increases in demands for rechargeable batteries having relatively high capacity and lighter weight. For example, a rechargeable lithium battery has recently drawn attention as a driving power source for portable devices, as it has lighter weight and high energy density. Accordingly, research for improving performances of rechargeable lithium is actively being conducted.

A rechargeable lithium battery includes a positive electrode and a negative electrode, which may include an active material being capable of intercalating and deintercalating lithium ions, and an electrolyte, and generate electrical energy due to an oxidation and reduction reaction when lithium ions are intercalated and deintercalated into the positive electrode and the negative electrode.

As for a positive active material of a rechargeable lithium battery, transition metal compounds such as lithium cobalt oxides, lithium nickel oxides, and lithium manganese oxides are mainly used. As the negative active material, a crystalline carbonaceous material such as natural graphite or artificial graphite, and/or an amorphous carbonaceous material, is used.

Nowadays, the negative active material layer has been thickly formed in order to improve the energy density of the rechargeable lithium battery, and especially, there is attempted to prepare a negative active material layer in the form of double layer using the silicon-based active material. However, this causes problems such as breakdown of the negative electrode due to the volume expansion and shrinkage of the silicon-based active material during charging and discharging.

The above information disclosed in this Background section is only for enhancement of understanding of the background of the subject matter of the present disclosure, and therefore it may contain information that does not form the prior art that is already known in this country to a person of ordinary skill in the art.

### SUMMARY

One embodiment provides a negative electrode for a rechargeable lithium battery exhibiting high energy density and cycle-life characteristics.

Another embodiment provides a rechargeable lithium battery including the negative electrode.

One embodiment provides a negative electrode including a current collector and a negative active material layer on the current collector and including a negative active material and a conductive material, the negative active material including a silicon-based active material and the conductive material including carbon nanotubes, wherein the negative active material and the conductive material are included in the negative active material layer in order to satisfy a relationship of Equation 1 and Equation 2.

26<A*B−{(C*D)/10}<55 Equation 1

600≤D≤1000 Equation 2

In Equations 1 and 2,

A is wt % of the silicon-based active material included in the negative active material layer,

B is a specific surface area (m²/g) according to gas adsorption of the silicon-based active material included in the negative active material layer,

C is wt % of carbon nanotubes included in the negative active material layer, and

D is a specific surface area (m²/g) according to gas adsorption of the carbon nanotubes included in the negative active material layer.

The silicon-based active material may include a composite of Si and carbon.

The specific surface area according to gas adsorption of the silicon-based active material may be about 1 m²/g to about 20 m²/g.

An amount of the negative active material may be about 95 wt % to about 99.99 wt % based on the total, 100 wt %, of the negative active material layer.

An amount of the carbon nanotubes may be about 0.01 wt % to about 5 wt % based on the total, 100 wt %, of the negative active material layer.

Another embodiment provides a method of preparing a negative electrode for a rechargeable lithium battery, including: distributing a conductive material having a specific surface area of about 600 m²/g to about 1000 m²/g according to gas adsorption in a solvent to prepare a distributed liquid having a specific surface area of about 60 m²/g to about 100 m²/g as measured by laser diffraction; adding a negative active material to the distributed liquid to prepare a composition for a negative active material layer; and coating the composition for the negative active material layer on a current collector, wherein the conductive material includes carbon nanotubes, and the negative active material includes a silicon-based active material.

The distributed liquid may include a conductive material, and a concentration of the dispersed liquid may be about 0.5 wt % to about 10 wt % based on the total weight of the distributed liquid.

Still another embodiment provides a negative electrode for a rechargeable lithium battery prepared by the method.

Still another embodiment provides a rechargeable lithium battery including the negative electrode, a positive electrode, and an electrolyte.

The negative active material according to one embodiment may exhibit high energy density and excellent cycle-life characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic view showing the structure of a lithium secondary battery according to an embodiment.

FIG. 2 is a graph showing the cycle-life characteristics of the cells according to Example 1 and Comparative Examples 1 to 3.

### DETAILED DESCRIPTION

Hereinafter, embodiments of the present disclosure are described in more detail. However, these embodiments are merely examples, the present disclosure is not limited thereto, and the present disclosure is defined by the scope of the appended claims, and equivalents thereof.

A negative electrode for a rechargeable lithium battery according to one embodiment includes a current collector and a negative active material layer on the current collector. The negative active material layer includes a negative active material and a conductive material (e.g., an electrically conductive material), and herein, the negative active material includes a silicon-based active material and the conductive material includes carbon nanotubes.

According to one embodiment, in the negative active material including the silicon-based active material as the negative active material and carbon nanotubes as the conductive material, the amount of the silicon-based active material and the amount of carbon nanotubes are suitably controlled depending on a specific surface area of the silicon-based active material and a specific surface area of the carbon nanotubes.

When it is illustrated in more detail, the silicon-based active material and carbon nanotubes may be included in the active material layer in order to satisfy the relationship of Equation 1 and Equation 2.

26<A*B−{(C*D)/10}<55 Equation 1

600≤D≤1000 Equation 2

In Equations 1 and 2,

A is wt % of the silicon-based active material included in the negative active material layer, for example, based on the total weight of the negative active material layer,

B is a specific surface area (m²/g) of the silicon-based active material according to gas adsorption of the silicon-based active material included in the negative active material layer,

C is wt % of carbon nanotubes included in the negative active material layer, for example, based on the total weight of the negative active material layer, and

D is a specific surface area (m²/g) of the carbon nanotubes according to gas adsorption of the carbon nanotubes included in the negative active material layer.

According to embodiments of the present disclosure, the carbon nanotube conductive material included in the negative active material layer may have a specific surface area according to gas adsorption of about 600 m²/g to about 1000 m²/g. When an amount of the conductive material having the foregoing specific surface area according to gas adsorption, and an amount of the silicon-based active material are adjusted in order to satisfy Equation 1, high energy density and an excellent cycle-life characteristic may be exhibited. For example, an amount of the conductive material and an amount of the silicon-based active material in the negative active material layer may be adjusted to achieve high energy density and excellent cycle-life characteristics.

The specific surface area according to gas adsorption, as described herein, generally refers to a value measured by using nitrogen gas, and for example, indicates a BET specific surface area.

Even though the silicon-based active material and the carbon nanotube conductive material are used, if the specific surface area according to gas adsorption and the amounts are not satisfied in Equation 1 and Equation 2, the energy density is deteriorated or reduced, and, for example, the cycle-life characteristic is significantly deteriorated or reduced.

Furthermore, the effects by satisfying the conditions of Equation 1 and Equation 2 may be more effectively obtained by using a conductive distributed liquid in which the conductive material is distributed.

The conductive distributed liquid is illustrated and described in more detail herein below.

In some embodiments, a conductive material (e.g., an electrically conductive material) having a specific surface area according to gas adsorption of about 600 m²/g to about 1000 m²/g is distributed in a solvent to prepare a distributed liquid (e.g., a conductive distributed liquid). The specific surface area of the distributed liquid may be measured by laser diffraction, which is used to measure a specific surface area of a liquid state, and the resulting distributed liquid may have a specific surface area found by laser diffraction of about 60 m²/g to about 100 m²/g. For example, the conductive material having a very large specific surface area, for example, a specific surface area found by gas adsorption of about 600 m²/g to about 1000 m²/g is distributed (e.g., dissolved or suspended) in a solvent to prepare a distributed liquid (e.g., a conductive distributed liquid).

The distribution (e.g., dissolution or suspension) may be performed by using any suitable techniques generally used in the art as long as the specific surface area found by the laser diffraction is reduced to be, as suitable or desired, about 60 m²/g to about 100 m²/g.

While the specific surface area of the conductive material may be about 600 m²/g to about 1000 m²/g, when the conductive material is distributed in the solvent and the specific surface area in the distributed liquid is measured to be about 60 m²/g to about 100 m²/g, and thus, the distributed liquid including the conductive material having a relatively small specific surface area may be prepared. For example, the specific surface of the distributed liquid is smaller than that of the conductive material due to the distribution of the conductive material in the solvent. In one embodiment, the specific surface area of the distributed liquid may be measured by instruments for measuring laser diffraction, for example, a Mastersizer 3000 (available from Malvern Panalytical, Ltd.) device, and the specific surface area by gas adsorption may be measured by using instruments such as a Quantachrome Inst. (Autosorb-iQ/MP) device using desorption and adsorption of nitrogen gas.

The solvent may be water, an alcohol, or combination thereof. The alcohol may be methanol, ethanol, propanol, or a combination thereof.

The conductive material may be carbon nanotubes, for example, single-walled carbon nanotubes, multi-walled carbon nanotubes, or a combination thereof, and, for example, may be single-walled carbon nanotubes.

If a negative electrode is prepared by using carbon nanotubes having a specific surface area of about 600 m²/g to 1000 m²/g, rather than the conductive distributed liquid in which the conductive material, which includes carbon nanotubes, having the described surface area is distributed, agglomerated carbon nanotubes are obtained that are larger than the active material, thereby substantially closing all of the pores in the negative electrode, and providing a conductive material that is not effectively or satisfactorily dispersed on a surface of the active material, and, consequently, suitable or sufficient desired effects are not obtained.

Indeed, if the active material is mixed together with the described conductive material in the form of a solid, rather than mixed together with a conductive material in the form of a distributed liquid, agglomerated carbon nanotubes are obtained that are larger than the active material, thereby substantially closing all of the pores in the negative electrode, and providing a conductive material that is not effectively or satisfactorily dispersed on a surface of the active material, and, consequently, suitable or sufficient desired effects are not obtained.

The distributed liquid including the conductive material, as described herein, may have a concentration of about 0.1 wt % to about 5 wt % (e.g., the conductive material may be present in the distributed liquid in an amount of about 0.1 wt % to about 5 wt %, based on the total weight of the distributed liquid). When the concentration of the distributed liquid including the conductive material is within the foregoing range, the distributed liquid may effectively prevent or reduce a reduction of the solid of the composition for the negative active material layer and allow preparation of a distributed liquid having a viscosity that allows suitable or sufficient flow in the preparation of the composition for the negative active material layer using the conductive distributed liquid.

The carbon nanotubes may have an average length of about 0.5 μm to about 20 μm, or about 1 μm to about 10 μm. Furthermore, the carbon nanotubes may have a width (diameter) of about 0.5 nm to about 3 nm, or about 1 nm to about 2 nm. The average length of carbon nanotubes does not indicate only a perfectly straight length, but may be a length corresponding to a long axis of the linear conductive material in the active material layer. The carbon nanotube conductive material having the foregoing average length and the foregoing width allows to readily contact the negative active material (e.g., may have suitable or sufficient physical contact with the negative active material).

The silicon-based active material of the negative active material may have a specific surface area by gas adsorption of about 1 m²/g to about 20 m²/g, or about 4 m²/g to 18 m²/g. The silicon-based active material having the specific surface area by gas adsorption which is in the foregoing range, may have features or advantages in which irreversible capacity may be reduced and a resistance for deintercalating lithium ions may be further decreased.

An amount of the silicon-based active material in the negative active material layer may be about 95 wt % to about 99.99 wt %, or about 95 wt % to about 99.95 wt %, based on the total, 100 wt %, of the negative active material layer. When the amount of the silicon-based active material is within the foregoing range, a battery having high energy density may be realized.

The silicon-based active material may be a composite of Si and carbon.

The composite of Si and carbon may include a composite of Si particles and a first carbon-based material. The first carbon-based material may include amorphous carbon and/or crystalline carbon. Examples of the composite may include a core in which Si particles are mixed together with a second carbon-based material, and a third-based material on and at least partially surrounding the core. The second carbon-based material and the third carbon-based material may be the same as or different each other, and may be amorphous carbon and/or crystalline carbon.

The amorphous carbon may include pitch carbon, soft carbon, hard carbon, mesophase pitch carbide, sintered cokes, carbon fiber, or a combination thereof, and the crystalline carbon may be artificial graphite, natural graphite, or a combination thereof.

The Si particles may have a particle diameter of about 10 nm to about 30 μm, and according to one embodiment, about 10 nm to about 1000 nm, and according to another embodiment, about 20 nm to about 150 nm. When the average particle diameter of the Si particles is within the foregoing range, the volume expansion caused during charging and discharging may be suppressed or reduced and the disconnection of the conductive path due to particle breakage during charging and discharging may be prevented or reduced.

In the present specification, a particle diameter may be the average particle diameter of the particles. In this case, the average particle diameter may mean a particle diameter (D50) measured as a cumulative volume. Such a particle diameter (D50) means the average particle diameter (D50), which means the diameter of particles having a cumulative volume of 50 volume % in the particle size distribution.

The average particle size (D50) may be measured by any suitable method that is generally used in the art, for example, by a particle size analyzer, by a transmission electron microscopic image, and/or by a scanning electron microscopic image. In some embodiments, a dynamic light-scattering measurement device may be used to obtain data, and data analysis may be performed by counting the number of particles for each particle size range. From this, the average particle diameter (D50) value may be obtained through a calculation.

When the composite of Si and carbon includes the Si particles and the first carbon-based material, an amount of the Si particles may be about 30 wt % to about 70 wt %, and according to one embodiment, about 40 wt % to about 50 wt % (e.g., based on the total weight of the composite). An amount of the first carbon-based material may about 70 wt % to about 30 wt %, and according to one embodiment, may be about 60 wt % to about 50 wt % (e.g., based on the total weight of the composite). When the amount of the Si particles and the first carbon-based material are within the range, high-capacity characteristics may be exhibited.

When the composite of Si and carbon includes a core in which the Si particles are mixed together with a second carbon-based material, and a third carbon-based material surrounding the core, the third carbon-based material may have a thickness of about 5 nm to about 100 nm. Furthermore, the third carbon-based material may be present in an amount of about 1 wt % to about 50 wt % based on the total, 100 wt % of the composite of Si and carbon the Si particles may be presented in an amount of about 30 wt % to about 70 wt % based on the total, 100 wt % of the composite of Si and carbon, and the second carbon-based material may be presented in an amount of about 20 wt % to about 69 wt % based on the total, 100 wt % of the composite of Si and carbon. When the amounts of the Si particles, the third carbon-based material, and the second carbon-based material are within the foregoing range, the discharge capacity may be excellent and the capacity retention may be improved.

The negative active material may further include a carbon-based active material, together with the silicon-based active material. The carbon-based active material may be artificial graphite, natural graphite, or a combination thereof.

When the carbon-based active material is further included as the negative active material, a mixing ratio of the carbon-based active material and the silicon-based active material may be about 0.1:99.9 wt % to about 97:3 wt %, about 50:50 wt % to about 97:3 wt %, or about 60:40 wt % to about 97:3 wt %. When the mixing ratio of the carbon-based active material and the silicon-based active material is within the foregoing range, the volume expansion of the negative active material may be more effectively suppressed or reduced and the conductivity (e.g., electrical conductivity) may be more improved (e.g., increased).

An amount of the negative active material in the negative active material layer may be about 95 wt % to about 99.5 wt % based on the total, 100 wt %, of the negative active material layer. The amount of the negative active material may be an amount of the silicon-based active material, or an amount of a mixture of the silicon-based active material and the carbon-based active material if the silicon-based active material and the carbon-based active material are mixed together and used as the negative active material.

The negative active material layer may further include a binder. When the negative active material layer further includes the binder, the negative active material may be included in the negative active material layer in an amount of about 94.99 wt % to about 90 wt % based on the total weight of the negative active material layer, the conductive material may be included in the negative active material layer in an amount of about 5 wt % to about 0.01 wt %, and the binder may be included in the negative active material layer in an amount of about 1 wt % to about 5 wt %.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylate polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may be a styrene-butadiene rubber (SBR), an acrylated styrene-butadiene rubber (ABR), an acrylonitrile-butadiene rubber, an acryl rubber, a butyl rubber, a fluorine rubber, an ethylene oxide-containing polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

When the aqueous binder is used as a negative electrode binder, a cellulose-based compound may be further used to provide (e.g., increase) viscosity as a thickener. The cellulose-based compound includes one or more of carboxymethyl cellulose, hydroxypropyl methyl cellulose, methyl cellulose, or alkali metal salts thereof. The alkali metal may be Na, K, and/or Li. The thickener may be included in an amount of about 0.1 parts by weight to about 3 parts by weight based on 100 parts by weight of the negative active material.

The current collector may include one selected from a copper foil, a nickel foil, a stainless steel foil, a titanium foil, a nickel foam, a copper foam, a polymer substrate coated with a conductive metal, and a combination thereof, but is not limited thereto.

Another embodiment provides a rechargeable lithium battery including the negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions. For example, one or more composite oxides of a metal selected from cobalt, manganese, nickel, and a combination thereof, and lithium, may be used. In some embodiments, the compounds represented by one of the following chemical formulae may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤C≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{b}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCₒG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂ PO₄₃ (0≤f≤2); Li_{(3-f)}Fe₂ PO₄₃ (0≤f≤2); LiₐFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on a surface thereof, or may be mixed together with another compound having a coating layer. The coating layer may include at least one coating element compound selected from the group consisting of an oxide of the coating element, a hydroxide of the coating element, an oxyhydroxide of the coating element, an oxycarbonate of the coating element, and a hydroxyl carbonate of the coating element. The compound for the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may be formed by any suitable method generally used in the art having no (or substantially no) adverse influence on properties of a positive electrode active material by using these elements in the compound, and for example, the method may include any suitable coating method such as spray coating, dipping, and/or the like, and further description thereof is not necessary here because it should be readily understood by those of ordinary skill in the art upon reviewing the present disclosure.

In the positive electrode, a content of the positive active material may be about 90 wt % to about 98 wt % based on the total weight of the positive active material layer.

In an embodiment, the positive active material layer may further include a binder and a conductive material (e.g., an electrically conductive material). Herein, the binder and the conductive material may be included in an amount of about 1 wt % to about 5 wt %, respectively based on the total amount of the positive active material layer.

The binder improves binding properties of positive electrode active material particles with one another and with a current collector. Examples of the binder may be polyvinyl alcohol, carboxymethyl cellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, acrylated styrene-butadiene rubber, an epoxy resin, nylon, and the like, but are not limited thereto.

The conductive material is included to provide electrode conductivity (e.g., electrical conductivity), and any suitable electrically conductive material may be used as a conductive material unless it causes a chemical change (e.g., an undesirable chemical change in a rechargeable lithium battery). Examples of the conductive material include a carbon-based material such as natural graphite, artificial graphite, carbon black, acetylene black, ketjen black, carbon fiber, and the like; a metal-based material of a metal powder and/or a metal fiber including copper, nickel, aluminum, silver, and the like; a conductive polymer such as a polyphenylene derivative; or a mixture thereof.

The current collector may use aluminum foil, nickel foil, or a combination thereof, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent may include cyclohexanone and/or the like. The alcohol-based solvent may include ethyl alcohol, isopropyl alcohol, and/or the like, and examples of the aprotic solvent include nitriles such as R—CN (where R is a C2 to C20 linear, branched, and/or cyclic hydrocarbon, and may include a double bond, an aromatic ring, and/or an ether bond), amides such as dimethylformamide, dioxolanes such as 1,3-dioxolane, sulfolanes, and/or the like.

The non-aqueous organic solvent may be used alone or in a mixture. When the organic solvent is used in a mixture, the mixture ratio may be controlled in accordance with suitable or desirable battery performance, and it may be any suitable mixture ratio generally used in the related art.

Furthermore, the carbonate-based solvent may suitably or desirably include a mixture including a cyclic carbonate and a linear carbonate. The cyclic carbonate and linear carbonate may be mixed together in a volume ratio of about 1:1 to about 1:9, and when the mixture is used as an electrolyte, it may have enhanced performance.

The organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

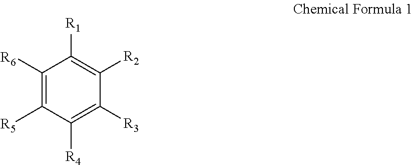

In Chemical Formula 1, R₁ to R₆ are the same or different and may each be selected from hydrogen, a halogen, a C1 to C10 alkyl group, a haloalkyl group, and a combination thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, an ethylene carbonate-based compound represented by Chemical Formula 2 as an additive for improving cycle life.

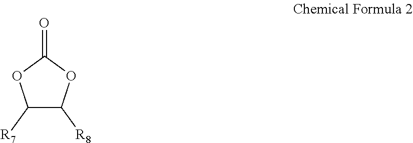

In Chemical Formula 2, R₇ and R₈ are the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, and/or fluoroethylene carbonate. An amount of the additive for improving the cycle-life characteristics may be used within a suitable or appropriate range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, e.g. an integer of 1 to 20), lithium difluoro(bisoxolato) phosphate), LiCl, LiI, LiB(C₂O₄)₂ (lithium bis(oxalato) borate: LiBOB) and lithium difluoro(oxalate)borate (LiDFOB). A concentration of the lithium salt may be in a range from about 0.1 M to about 2.0 M. When the lithium salt is included at the above concentration range, an electrolyte may have excellent performance and lithium ion mobility due to suitable or optimal electrolyte conductivity (e.g., electrical conductivity) and viscosity.

A separator may be between the positive electrode and the negative electrode depending on a type (or kind) of a rechargeable lithium battery. The separator may use polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

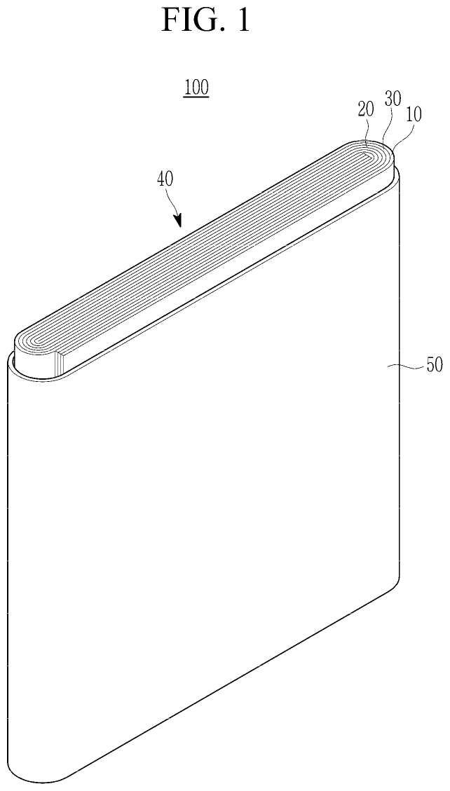

FIG. 1 is an exploded perspective view of a rechargeable lithium battery according to an embodiment. The rechargeable lithium battery according to an embodiment is illustrated as a prismatic battery, but is not limited thereto, and may include variously-shaped batteries such as a cylindrical battery, a pouch battery, and the like.

Referring to FIG. 1, a rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Example 1

Single-walled carbon nanotubes having a BET specific surface area of 960 m²/g (average length: 1 μm to 10 μm, width (diameter): 1 nm to 3 nm) as a conductive material was added to a water solvent and distributed to prepare a conductive material distributed liquid. The obtained conductive material distributed liquid had a laser diffraction specific surface area of 96 m²/g, and had a concentration of 2.5 wt % (included 2.5 wt % of the single-walled carbon nanotubes based on the total weight of the conductive material distributed liquid).

A graphite negative active material, a Si-carbon composite (BET specific surface area of 5 m²/g) negative active material, the conductive material distributed liquid, a carboxymethyl cellulose thickener and a styrene-butadiene rubber binder were mixed together in a water solvent to prepare a negative active material layer slurry.

In the mixing, the respective amounts of the materials were graphite negative active material at 85 wt %, Si-carbon composite at 11 wt %, single-walled carbon nanotube conductive material at 0.05 wt %, carboxymethyl cellulose thickener at 1.95 wt %, and styrene-butadiene rubber at 2 wt %, as amounts of solids, based on the total weight of the solids.

Herein, the Si-carbon composite was used as a Si-carbon composite including a core including an artificial graphite and silicon particles, and a soft carbon coating layer on a surface of the core. The soft carbon coating layer had a thickness of 20 nm and the silicon particles had an average particle diameter D50 of 100 nm.

The negative active material layer slurry was coated on a copper foil current collector, dried, and pressed to prepare a negative electrode.

Using the negative electrode, a polyethylene/polypropylene separator, a lithium metal counter electrode, and an electrolyte solution, a half-cell was fabricated by a general procedure.

The electrolyte included 1.5 M LiPF₆ dissolved in a mixed solvent of ethylene carbonate, ethylmethyl carbonate, and dimethyl carbonate (20:10:70 volume ratio).

### Example 2

Single-walled carbon nanotubes having a BET specific surface area of 600 m²/g (average length: 1 μm to 10 μm, width (diameter): 1 nm to 3 nm) as a conductive material was added to a water solvent and distributed to prepare a conductive material distributed liquid. The obtained conductive material distributed liquid had a laser diffraction specific surface area of 60 m²/g, and had a concentration of 2.5 wt % (included 2.5 wt % of the single-walled carbon nanotubes based on the total weight of the conductive material distributed liquid).

A negative electrode and a half-cell were fabricated by substantially the same procedure as in Example 1, except that the conductive material distributed liquid of Example 2 was used.

### Example 3

Single-walled carbon nanotubes having a BET specific surface area of 1000 m²/g (average length: 1 μm to 10 μm, width (diameter): 1 nm to 3 nm) as a conductive material was added to a water solvent and distributed to prepare a conductive material distributed liquid. The obtained conductive material distributed liquid had a laser diffraction specific surface area of 100 m²/g, and had a concentration of 2.5 wt % (included 2.5 wt % of the single-walled carbon nanotubes based on the total weight of the conductive material distributed liquid).

A negative electrode and a half-cell were fabricated by substantially the same procedure as in Example 1, except that the conductive material distributed liquid of Example 3 was used.

### Example 4

Single-walled carbon nanotubes having a BET specific surface area of 900 m²/g (average length: 1 μm to 10 μm, width (diameter): 1 nm to 3 nm) as a conductive material was added to a water solvent and distributed to prepare a conductive material distributed liquid. The obtained conductive material distributed liquid had a laser diffraction specific surface area of 90 m²/g, and had a concentration of 2.5 wt % (included 2.5 wt % of the single-walled carbon nanotubes based on the total weight of the conductive material distributed liquid).

A graphite negative active material, a Si-carbon composite (BET specific surface area of 7 m²/g) negative active material, the conductive material distributed liquid, a carboxymethyl cellulose thickener, and a styrene-butadiene rubber binder were mixed together in a water solvent to prepare a negative active material layer slurry.

In the mixing, the respective amounts of the materials were graphite negative active material at 91.5 wt %, Si-carbon composite (BET specific surface area of 7 m²/g) at 4.5 wt %, the conductive material at 0.05 wt %, a carboxymethyl cellulose thickener at 1.95 wt %, and styrene-butadiene rubber at 2 wt %, as an amount of solids, based on the total weight of the solids. Herein, the Si-carbon composite was used as a Si-carbon composite including a core including an artificial graphite and silicon particles, and a soft carbon coating layer on a surface of the core. The soft carbon coating layer had a thickness of 20 nm and the silicon particle had an average particle diameter D50 of 100 nm.

Using the negative active material layer slurry, a negative electrode and a half-cell were fabricated by substantially the same procedure as in Example 1.

### Comparative Example 1

85 wt % of a graphite negative active material, 11 wt % of a Si-carbon composite (BET specific surface area of 5 m²/g) negative active material used in Example 1, 0.05 wt % of a ketjen black conductive material, 1.95 wt % of a carboxymethyl cellulose thickener, and 2 wt % of a styrene-butadiene rubber binder, with the wt % based on the total weight of the solids, were mixed together in a water solvent to prepare a negative active material layer slurry.

Herein, the Si-carbon composite was used as a Si-carbon composite including a core including an artificial graphite and silicon particles, and a soft carbon coating layer on a surface of the core. The soft carbon coating layer had a thickness of 20 nm and the silicon particle had an average particle diameter D50 of 100 nm.

Using the negative active material layer slurry, a negative electrode and a half-cell were fabricated by substantially the same procedure as in Example 1.

### Comparative Example 2

92.2 wt % of a graphite negative active material, 3.8 wt % of a Si-carbon composite (BET specific surface area of 16.2 m²/g) negative active material, 0.05 wt % of single-walled carbon nanotubes having a BET specific surface area of 960 m²/g (average length: 1 μm to 10 μm, width (diameter): 1 nm to 3 nm) conductive material, 1.95 wt % of a carboxymethyl cellulose thickener, and 2 wt % of a styrene-butadiene rubber binder, with the wt % based on the total weight of the solids, were mixed together in a water solvent to prepare a negative active material layer slurry.

Herein, the Si-carbon composite was used as a Si-carbon composite including a core including an artificial graphite and silicon particles, and a soft carbon coating layer on a surface of the core. The soft carbon coating layer had a thickness of 20 nm and the silicon particles had an average particle diameter D50 of 800 nm.

Using the negative active material layer slurry, a negative electrode and a half-cell were fabricated by substantially the same procedure as in Example 1.

### Comparative Example 3

91.5 wt % of a graphite negative active material, 4.5 wt % of a Si-carbon composite (BET specific surface area of 6.3 m²/g) negative active material, 0.05 wt % of single-walled carbon nanotubes having a BET specific surface area of 960 m²/g (average length: 1 μm m to 10 μm, width (diameter): 1 nm to 3 nm) conductive material, 1.95 wt % of a carboxymethyl cellulose thickener, and 2 wt % of a styrene-butadiene rubber binder, with the wt % based on the total weight of the solids, were mixed together in a water solvent to prepare a negative active material layer slurry.

Herein, the Si-carbon composite was used as a Si-carbon composite including a core including artificial graphite and silicon particles, and a soft carbon coating layer on a surface of the core. The soft carbon coating layer had a thickness of 20 nm and the silicon particle had an average particle diameter D50 of 135 nm.

Using the negative active material layer slurry, a negative electrode and a half-cell were fabricated by substantially the same procedure as in Example 1.

### Comparative Example 4

A negative active material layer slurry was prepared by substantially the same procedure as in Example 1 except that single-walled carbon nanotubes having a BET specific surface area of 590 m²/g, average length: 1 μm to 10 μm, width (diameter: 1 nm to 3 nm) was used to prepare a conductive material distributed liquid. The obtained conductive material distributed liquid had a laser diffraction specific surface area of 59 m²/g, and had a concentration of 1.0 wt % (included 1.0 wt % of the single-walled carbon nanotubes based on the total weight of the conductive material distributed liquid).

The negative active material layer slurry was coated on the copper foil current collector. However, the extremely low viscosity of the slurry (150 cps) caused separation of the negative active material layer from the current collector, during the drying, so that a negative electrode could not be prepared.

### Comparative Example 5

A negative active material layer slurry was prepared by substantially the same procedure as in Example 1 except that single-walled carbon nanotubes having a BET specific surface area of 1010 m²/g, average length: 1 μm to 10 μm, width (diameter): 1 nm to 3 nm) was used to prepare a conductive material distributed liquid. The obtained conductive material distributed liquid had a laser diffraction specific surface area of 101 m²/g, and had a concentration of 4.0 wt % (included 4.0 wt % of the single-walled carbon nanotubes based on the total weight of the conductive material distributed liquid).

The coating using the negative active material layer slurry on the copper foil current collector was performed, but surface protrusions on a surface of the coatings were largely formed, and the negative active material layer slurry did not completely coat the copper foil, so that a negative electrode could not be prepared.

### Experimental Example 1) Measurements of Laser Diffraction Specific Surface Area of the Conductive Material Distributed Liquid and BET Specific Surface Area of the Conductive Material in Negative Electrode

The BET specific surface areas for the conductive materials in the negative electrodes according to Examples 1 to 4 and Comparative Examples 1 to 3 were measured by using a Quantachrome Inst. (Autosorb-iQ/MP) instrument which utilized desorption and adsorption of nitrogen gas. The results thereof are shown in Table 1.

The laser diffraction specific surface area for the conductive material distributed liquid of Examples 1 to 4 and Comparative Examples 4 and 5 were measured by using Mastersizer 3000 (available from Malvern Panalytical, Ltd) equipment. The results thereof are shown in Table 1.

The BET specific surface area of the silicon-carbon composite (referred to as a Si—C composite) and the amount of Si—C composite included in the negative active material layer are shown in Table 1. The value according to Equation 1 was calculated from the amount (A) and the BET specific surface area (B) of the Si—C composite negative active material, and an amount (C) and the BET specific surface area (D) of the single-walled carbon nanotubes (SWCNT). The results thereof are shown in Table 1.

E=A*B−{(C*D)/10} Equation 1

TABLE 1

| | | BET specific | | BET specific | | Laser diffraction |
|---|---|---|---|---|---|---|
| | | surface area | | surface area of | | specific surface |
| | Amount of | of Si—C | Amount of | SWCNT in negative | Equation 1 | area of conductive |
| | Si—C composite | composite | SWCNT | electrode | value | material distributed |
| | (wt %, A) | (m²/g, B) | (wt %, C) | (m²/g, D) | (E) | liquid |
| Example 1 | 11 | 5 | 0.05 | 960 | 50.2 | 96 |
| Example 2 | 11 | 5 | 0.05 | 600 | 52 | 60 |
| Example 3 | 11 | 5 | 0.05 | 1000 | 50 | 100 |
| Example 4 | 4.5 | 7 | 0.05 | 900 | 27 | 90 |
| Comparative | 11 | 5 | 0 | 0 | 55 | — |
| Example 1 | | | | | | |
| Comparative | 3.8 | 16.2 | 0.05 | 960 | 56.76 | — |
| Example 2 | | | | | | |
| Comparative | 4.5 | 6.3 | 0.05 | 960 | 23.55 | — |
| Example 3 | | | | | | |
| Comparative | 11 | 5 | 0.05 | 590 | 52.05 | 59 |
| Example 4 | | | | | | |
| Comparative | 11 | 5 | 0.05 | 1010 | 49.95 | 101 |
| Example 5 | | | | | | |

### Experimental Example 2) Evaluation of Capacity Retention

The half-cells according to Examples 1 to 4 and Comparative Examples 1 to 5 were charged and discharged at room temperature of 25° C. under the following charge and discharge conditions for 350 cycles.

Charge: constant current-constant voltage, 0.33 C, 4.2 V, 0.05 C cut-of and pausing for 10 minutes

Discharge: constant current 1.0 C, 2.5 V cut-off, and pausing for 10 minutes

The ratio of the discharge capacity at each cycle to the discharge capacity at 1^{st} were measured. The results thereof are shown in Table 2. The status for Comparative Examples 4 and 5 are shown in Table 1.

TABLE 2

| | Capacity retention (%) |
|---|---|
| Example 1 | 89% |
| Example 2 | 88% |
| Example 3 | 89% |
| Example 4 | 88% |
| Comparative | 79% |
| Example 1 | |
| Comparative | Reduction of to be 70% or less at 230 cycles |
| Example 2 | |
| Comparative | 87% |
| Example 3 | |
| Comparative | Unable to coat (low viscosity of slurry caused |
| Example 4 | separation in coating) |
| Comparative | Unable to coat (formation of large protrusions on the |
| Example 5 | surface of the coatings due to non-distributed |
| | SWCNT, which caused it to not coat) |

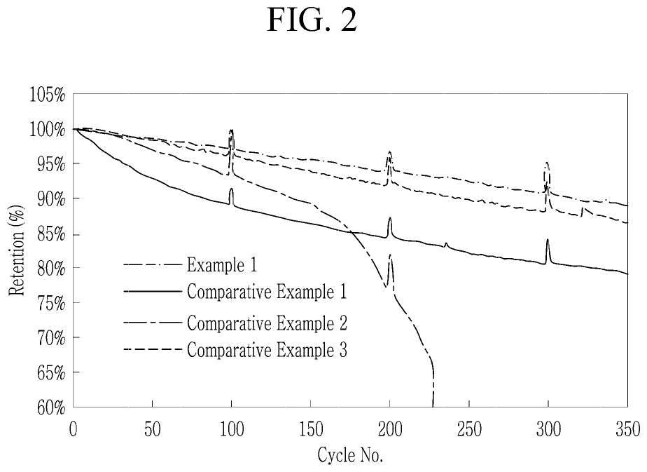

The results according to Example 1 and Comparative Examples 1 to 3 are shown in FIG. 2.

As shown in Table 2 and FIG. 2, Example 1 to 4 exhibited good capacity retention compared to Comparative Examples 1 to 3.

Even though it satisfied Equation 1, the BET specific surface area of SWCNT is lower (Comparative Example 4) or higher (Comparative Example 5), and the coating was not successful, and thus, a negative electrode was not prepared.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the scope of the appended claims and attached drawings the present disclosure.

What is claimed is:

1. A negative electrode for a rechargeable lithium battery, comprising:
a current collector; and
a negative active material layer on the current collector and comprising a negative active material and a conductive material,
wherein the negative active material comprises a silicon-based active material,
wherein the conductive material comprises carbon nanotubes, and
wherein the negative active material and the conductive material are comprised in the negative active material layer in order to satisfy a relationship of Equation 1 and Equation 2:
26<A*B−{(C*D)/10}<55 Equation 1
600≤D≤1000 Equation 2
wherein, in Equations 1 and 2,
A is wt % of the silicon-based active material comprised in the negative active material layer,
B is a specific surface area (m²/g) according to gas adsorption of the silicon-based active material comprised in the negative active material layer,
C is wt % of carbon nanotubes comprised in the negative active material layer, and
D is a specific surface area (m²/g) according to gas adsorption of the carbon nanotubes comprised in the negative active material layer.

2. The negative electrode for a rechargeable lithium battery of claim 1, wherein the silicon-based active material comprises a composite of Si and carbon.

3. The negative electrode for a rechargeable lithium battery of claim 1, wherein the specific surface area according to gas adsorption of the silicon-based active material is about 1 m²/g to about 20 m²/g.

4. The negative electrode for a rechargeable lithium battery of claim 1, wherein an amount of the negative active material is about 95 wt % to about 99.99 wt % based on the total, 100 wt % of the negative active material layer.

5. The negative electrode for a rechargeable lithium battery of claim 1, wherein an amount of the carbon nanotubes is about 0.01 wt % to about 5 wt % based on the total, 100 wt % of the negative active material layer.

6. A method of preparing a negative electrode for a rechargeable lithium battery, comprising:
distributing a conductive material having a specific surface area of about 600 m²/g to about 1000 m²/g according to gas adsorption in a solvent to prepare a distributed liquid having a specific surface area of about 60 m²/g to about 100 m²/g as measured by laser diffraction;
adding a negative active material to the distributed liquid to prepare a composition for a negative active material layer; and
coating the composition for the negative active material layer on a current collector,
wherein the conductive material comprises carbon nanotubes, and
wherein the negative active material comprises a silicon-based active material.

7. The method of preparing a negative electrode for a rechargeable lithium battery of claim 6, wherein the distributed liquid comprising the conductive material has a concentration of about 0.1 wt % to about 5 wt % based on the total weight of the distributed liquid.

8. The method of preparing a negative electrode for a rechargeable lithium battery of claim 6, wherein the silicon-based active material comprises a composite of Si and carbon.

9. A negative electrode for a rechargeable lithium battery prepared by the method of claim 6.

10. A rechargeable lithium battery, comprising:
the negative electrode of claim 1;
a positive electrode; and
an electrolyte.

11. A rechargeable lithium battery, comprising:
the negative electrode of claim 9;
a positive electrode; and
an electrolyte.
